(19) United States
(12) Patent Application Publication
(10) Pub. No.: US 2015/0071635 A1
(43) Pub. Date: Mar. 12, 2015

(54) APPARATUS AND METHOD FOR EFFECTIVE DESIGN OF A COMMUNICATION NETWORK ENABLING LARGE-CAPACITY TRANSMISSION

(71) Applicant: FUJITSU LIMITED, Kawasaki-shi (JP)

(72) Inventors: TAKAO NAITO, Musashino (JP); KAZUYUKI TAJIMA, Yokosuka (JP); YUTAKA TAKITA, Kawasaki (JP); TOMOHIRO HASHIGUCHI, Inagi (JP)

(73) Assignee: FUJITSU LIMITED, Kawasaki-shi (JP)

(21) Appl. No.: 14/458,324

(22) Filed: Aug. 13, 2014

(30) Foreign Application Priority Data
Sep. 11, 2013 (JP) 2013-188567

(51) Int. Cl. H04Q 11/00; H04L 12/721; H04L 12/24; H04J 14/02

(52) U.S. Cl. CPC H04Q 11/0066; H04J 14/0257; H04L 45/62; H04L 41/145; H04Q 2011/0073; H04Q 2011/0086
USPC 398/49

(57) ABSTRACT

An apparatus designs a communication route for each of requested channels by selecting, with higher priority, first transmission-paths providing connections between particular nodes in a network in which a wavelength-multiplexed optical signal is transmitted than second transmission-paths providing connections between three or more nodes in the network, and assigns, for each channel, a wavelength included in the wavelength-multiplexed optical signal. Between the particular nodes, when the number of wavelengths assigned to channels passing through the first transmission-paths is greater than the number of wavelengths assigned to channels passing through the second transmission-paths, the apparatus modifies the designed communication routes and the assigned wavelengths so that, via any of the particular nodes, one of two channels having the same wavelength is routed from the first transmission-paths to the second transmission-paths and the other one of the two channels is routed from the second transmission-paths to the first transmission-paths.

### CROSS-REFERENCE TO RELATED APPLICATION

This application is based upon and claims the benefit of priority of the prior Japanese Patent Application No. 2013-188567 filed on Sep. 11, 2013, the entire contents of which are incorporated herein by reference.

### FIELD

The embodiment discussed herein is related to apparatus and method for effective design of a communication network enabling large-capacity transmission.

### BACKGROUND

With an increase in communication demand because of the widening use of cloud services, smartphones, and so on, optical networks utilizing wavelength division multiplexing (WDM) have come into widespread use. Wavelength division multiplexing is a technology for transmitting multiplexed optical signals having different wavelengths.

With wavelength division multiplexing, for example, optical signals with 88 wavelengths and a transmission speed of 40 Gbps may be multiplexed and transmitted as a wavelength-multiplexed optical signal (hereinafter referred to as a “multiplexed optical signal”). One known example of wavelength division multiplexing transmission equipment utilizing WDM is reconfigurable optical add-drop multiplexer (ROADM) equipment.

Although the transmission capacities of wavelength division multiplexing transmission equipment are increasing, the transmission capacities of optical fibers for transmitting multiplexed optical signals are limited. For example, the wavelength bands of light that propagates through optical fibers are limited because of the physical properties of the optical fibers. Examples of the wavelength bands include the conventional band (C band) and the long band (L band).

In recent years, with anticipation of an increase in future communication demand, attempts are being made to realize coherent transmission by applying a polarization multiplexing (dual polarization) system or a multilevel modulation system, such as quaternary phase-shift keying (QPSK) used for wireless communication, to wavelength division multiplexing transmission equipment. In order to increase the communication capacity, a multilevel modulation system for a larger amount of data and a higher-density frequency multiplexing technology are used. However, the communication capacity is approaching Shannon's theoretical limit.

Thus, in network design, a scheme for providing an optical fiber cable accommodating a plurality of optical fibers between the same nodes is conceivable to increase the transmission capacity between pieces of wavelength division multiplexing transmission equipment. An optical fiber cable accommodates a plurality of optical fibers (for example, hundreds to thousands of optical fibers) within its sheath. With respect to network design, for example, Japanese National Publication of International Patent Application No. 2005-032076 discloses a scheme for designing optimum paths in an optical network.

### SUMMARY

According to an aspect of the invention, an apparatus designs a communication route for each of requested communication channels by selecting, with higher priority, first transmission paths that provide connections between particular nodes in a network in which a wavelength-multiplexed optical signal is transmitted than second transmission paths that provide connections between three or more nodes in the network, and assigns, for each communication channel, a wavelength included in the wavelength-multiplexed optical signal. When a first number of wavelengths assigned to the communication channels passing through the first transmission paths between the particular nodes is greater than a second number of wavelengths assigned to the communication channels passing through the second transmission paths between the particular nodes, the apparatus modifies, the designed communication routes and the assigned wavelengths so that one of two communication channels to which a same wavelength is assigned is routed from the first transmission path to the second transmission path via any of the particular nodes and other one of the two communication channels is routed from the second transmission path to the first transmission path via any of the particular nodes.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network in which transmission paths and nodes are made redundant;

FIG. 2 is a diagram illustrating an example of a network in which transmission paths are made redundant;

FIG. 3 is a diagram illustrating an example of a network in which transmission paths between particular nodes are made redundant;

FIG. 4 is a diagram illustrating an example of wavelength division multiplexing transmission equipment at a general node;

FIG. 5 is a diagram illustrating an example of wavelength division multiplexing transmission equipment at a local node;

FIG. 6 is a diagram illustrating an example of a configuration of a network design apparatus, according to an embodiment;

FIG. 7 is a diagram illustrating an example of a function configuration of a central processing unit (CPU) and information stored in a hard disk drive (HDD), according to an embodiment;

FIG. 8 is a diagram illustrating an example of demand information, according to an embodiment;

FIG. 9 is a diagram illustrating an example of a turn-back route;

FIG. 10 is a diagram illustrating an example of a network in which transmission paths between particular nodes are made redundant;

FIG. 11 is a diagram illustrating an example of design of communication routes, according to an embodiment;

FIGS. 12A and 12B are diagrams illustrating an example of communication routes before modification and an example of communication routes after the modification, according to an embodiment;

FIG. 13 is a diagram illustrating an example of the communication routes after the modification, according to an embodiment;

FIG. 14 is a diagram illustrating an example of modifications of communication routes, according to an embodiment;

FIG. 15 is a diagram illustrating an example of an operational flowchart for a network design method, according to an embodiment;

FIG. 16 is a diagram illustrating an example of an operational flowchart for communication-route design processing, according to an embodiment;

FIG. 17 is a diagram illustrating an example of an operational flowchart for communication-route and wavelength modification processing, according to an embodiment; and

FIG. 18 is a diagram illustrating an example of costs for respective network configurations, according to an embodiment.

### DESCRIPTION OF EMBODIMENT

The wavelength division multiplexing transmission equipment at each node has components (for example, wavelength selective switches and optical amplifiers) for pathways corresponding to the number of optical fibers. Thus, when a plurality of optical fibers are provided between nodes, there is a problem in that the equipment cost increases. In this case, since transmission route candidates corresponding to the number of optical fibers exist during selection of transmission routes that provide connection between predetermined nodes, there is also a problem in that the network design becomes complicated.

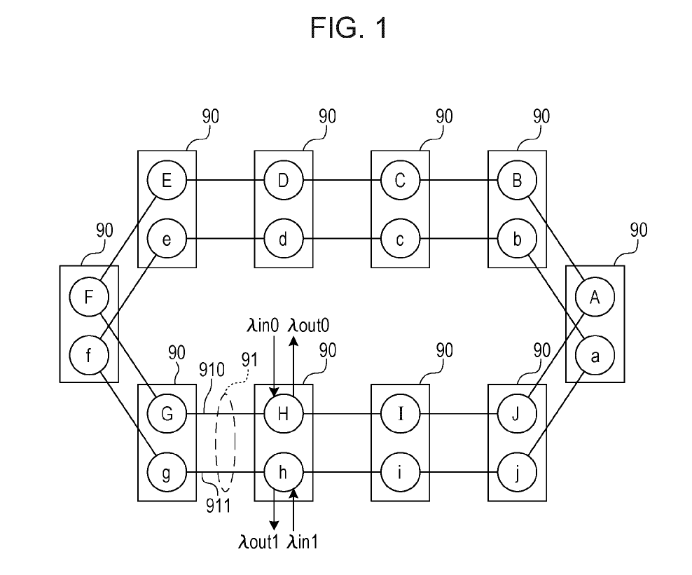

FIG. 1 is a diagram illustrating an example of a network in which transmission paths and nodes are made redundant. This network includes nodes A to J and nodes a to j provided in exchanges 90. Although a case in which a network to be designed is a ring network is described in this example, the embodiment is not limited thereto, and the network may be a network having another architecture, such as a linear or mesh network.

The nodes A to J are connected to each other through first transmission paths 910, and the nodes a to j are connected through second transmission paths 911. Thus, the nodes A to J and the nodes a to j are independent from each other in the network. The first transmission paths 910 and the second transmission paths 911 each include a pair of optical fibers that transmit light in directions opposite to each other. The first transmission paths 910 and the second transmission paths 911 are accommodated in the same optical fiber cables (communication cables) 91.

At the nodes A to J and a to j, respective pieces of wavelength division multiplexing transmission equipment, such as ROADMs, are provided. Thus, each piece of the wavelength division multiplexing transmission equipment at the nodes A to J wavelength-multiplexes an optical signal λin0, input (inserted) from an external network (not illustrated), with another optical signal and transmits the resulting signal to the adjacent node as a multiplexed optical signal. Each piece of the wavelength division multiplexing transmission equipment at the nodes A to J also splits (branches) an optical signal λout0 from a multiplexed optical signal transmitted from the adjacent node and outputs the resulting signals to an external network. Each piece of the wavelength division multiplexing transmission equipment at the nodes a to j also transmits an optical signal λin1, input from an external network, to the adjacent node as a multiplexed optical signal and splits an optical signal λout1 from a multiplexed optical signal transmitted from the adjacent node. A network management apparatus (not illustrated) sets, for pieces of the wavelength division multiplexing transmission equipment at the nodes A to J and a to j, the wavelengths of optical signals that are inserted and the wavelengths of optical signals that are branched.

Thus, in the network in this example, a communication channel may be provided between arbitrary nodes (except between the nodes A to J and the nodes a to j). The pieces of wavelength division multiplexing transmission equipment at the nodes A to J are connected to the corresponding first transmission paths 910, and the pieces of wavelength division multiplexing transmission equipment at the nodes a to j are connected to the corresponding second transmission paths 911, thus providing two pathways (that is, transmission paths connected to the adjacent nodes).

In the network in this example, the exchanges 90 are connected to each other through the optical fiber cables 91. Thus, the network has a transmission capacity twice as large as that of a network in which the nodes are not made redundant. However, since the nodes in the exchanges 90 are also made redundant, the equipment cost and the operating cost are also twice as high as those in a network in which the nodes are not made redundant. In the network in this example, since the nodes A to J and the nodes a to j are connected through the individual transmission paths 910 and 911, a requested communication channel is distributed to either of the two transmission paths 910 and 911 in the network design. Thus, when this network is used to provide a communication service, there is the inconvenience that optical signals of customers that receive the communication service provided using the different transmission paths 910 and 911 are not inter-connectable in the form of light without converting the optical signals into electrical signals, since two sub-networks respectively including the different transmission paths 910 and 911 are independent from each other.

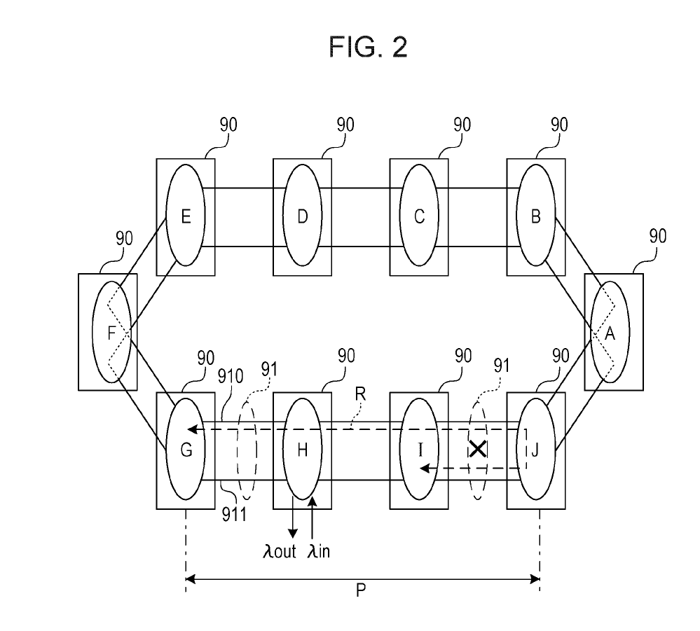

Accordingly, in order to reduce the number of nodes, the nodes A to J and the nodes a to j may be integrated together in the exchanges 90 to configure a network in which the transmission paths are made redundant. FIG. 2 is a diagram illustrating an example of a network in which transmission paths are made redundant. In FIG. 2, elements that are the same as or similar to those in FIG. 1 are denoted by the same reference numerals, and descriptions thereof are not given hereinafter.

In the network in this example, exchanges 90 are provided with respective nodes A to J. The nodes A to J are connected to each other through first transmission paths 910 and second transmission paths 911. Thus, each piece of the wavelength division multiplexing transmission equipment provided in the nodes A to J has four pathways.

In this example network, although the number of nodes in each exchange 90 is reduced to one, the number of pathways at each wavelength division multiplexing transmission equipment increases, and thus cost is not reduced sufficiently. In addition, since each of the nodes A to J is connected to both the first transmission paths 910 and the second transmission paths 911, a single network is formed. Thus, in this network, the inconvenience related to the interconnection described above with reference to FIG. 1 does not occur.

However, since two candidate transmission paths 910 and 911 exist for each of the nodes A to J, design of a communication route for a communication channel is complicated. For example, when a communication channel P is requested between the nodes G and J, the number of communication-route candidates for the communication channel P is 8 (=2×2×2), since two candidate transmission paths exist between the nodes G and H, two between the nodes H and I, and two between the nodes I and J. Hence, it is desired that the communication route design be simplified.

Also, in the networks illustrated in FIGS. 1 and 2, the nodes A to J and the nodes a to j are connected to each other through the optical fiber cables 91 accommodating the plurality of optical fibers. Thus, for example, when any of the optical fiber cables 91 is broken, failures may occur in the plurality of the optical fibers accommodated therein at the same time. When failures occur in the plurality of optical fibers at the same time, a problem arises in that the multiple failures make it difficult to re-establish communication channels.

For example, in FIG. 2, when the optical fiber cable 91 between the node I and the node J is broken (see mark ×), failures occur in both of the first transmission path 910 and the second transmission path 911 in the section. In this case, multiple failures occur in a communication route R that originates at the node G, turns back at the node J, and reaches the node I. Thus, it is desirable that the network using the optical fiber cables 91 be designed so as to avoid multiple failures.

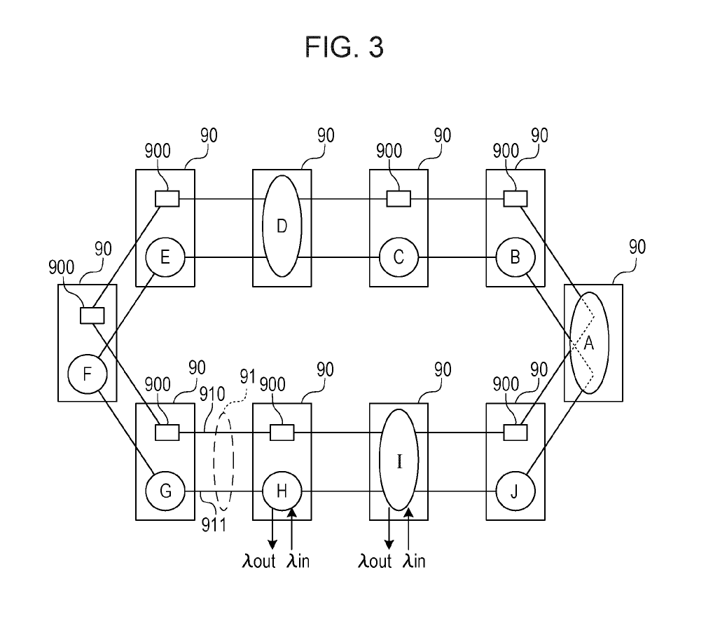

FIG. 3 is a diagram illustrating an example of a network in which transmission paths between particular nodes are made redundant. In FIG. 3, elements that are the same as or similar to those in FIG. 1 are denoted by the same reference numerals, and descriptions thereof are not given hereinafter.

In the network in this example, only particular nodes A, D, and I are connected to first transmission paths 910, and other nodes B, C, E to H, and J are connected to only second transmission paths 911. In exchanges in which the nodes B, C, E to H, and J are provided, the first transmission paths 910 are coupled to each other via optical connectors 900. The first transmission paths 910 may also be coupled to each other via optical amplifiers, instead of the optical connectors 900.

According to this configuration, the second transmission paths 911 provide connections between all (three or more) the nodes A to J in the network, and the first transmission paths 910 provide connections between the particular nodes A, D, and I in the network. This makes it easier to selectively use the first transmission paths 910 and the second transmission paths 911, thus simplifying the design of communication routes. If this network is compared to a railroad, the first transmission paths 910 correspond to local lines, and the second transmission paths 911 correspond to express lines. The particular nodes A, D, and I correspond to express train stations, and the other nodes B, C, E to H, and J correspond to regular stations. In the following description, the nodes A, D, and I are referred to as “general nodes”, and the nodes B, C, E to H, and J are referred to as “local nodes”. Also, the first transmission paths 910 are referred to as “sub transmission paths”, and the second transmission paths 911 are referred to as “main transmission paths”.

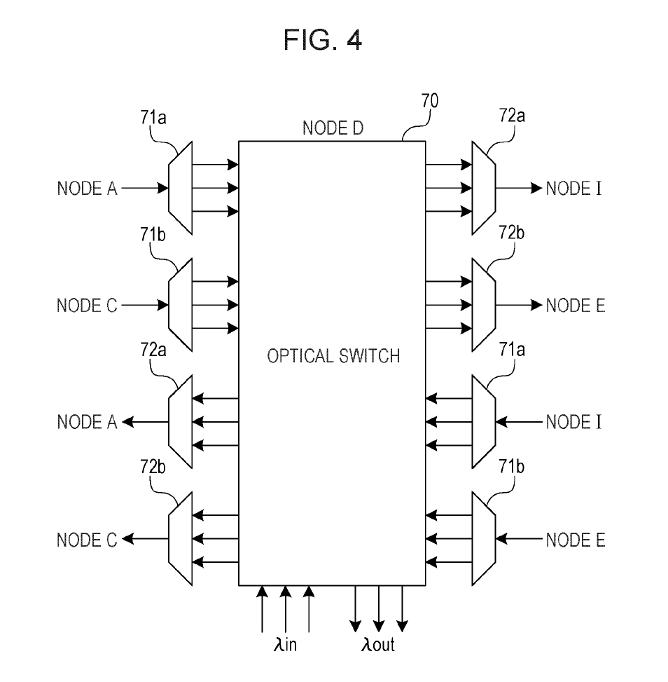

FIG. 4 is a diagram illustrating an example of the wavelength division multiplexing transmission equipment at the general nodes A, D, and I. Although FIG. 4 illustrates the configuration of the wavelength division multiplexing transmission equipment at the general node D, the configurations of the wavelength division multiplexing transmission equipment at the other general nodes A and I are also substantially the same.

The wavelength division multiplexing transmission equipment has four multiplexers 72a and 72b, four demultiplexers 71a and 71b, and an optical switch 70. Each of the demultiplexers 71a and 71b demultiplexes an input multiplexed optical signal by splitting optical signals with different wavelengths and outputs the resulting optical signals to the optical switch 70. The demultiplexers 71a are connected to the corresponding adjacent general nodes A and I through the sub transmission paths 910, and the demultiplexers 71b are connected to the corresponding adjacent local nodes C and E through the main transmission paths 911.

The optical switch 70 switches between destinations to which optical signals are to be output. The optical switch 70 outputs multiplexed optical signals, input from the demultiplexers 71a and 71b, or optical signals λin, input from an external network, to the multiplexers 72a and 72b corresponding to the pathways to which the optical signals are to be output. The optical switch 70 also outputs only optical signals λout to be branched to an external network, out of the optical signals being included in optical signals that have been split according to the wavelengths by the demultiplexers 71a and 71b.

Each of the multiplexers 72a and 72b multiplexes optical signals with different wavelengths. Each of the multiplexers 72a and 72b multiplexes optical signals input from the optical switch 70 to generate a multiplexed optical signal and outputs the multiplexed optical signal. The multiplexers 72a are connected to the corresponding adjacent general nodes I and A through the sub transmission paths 910, and the multiplexers 72b are connected to the corresponding adjacent local nodes E and C through the main transmission paths 911.

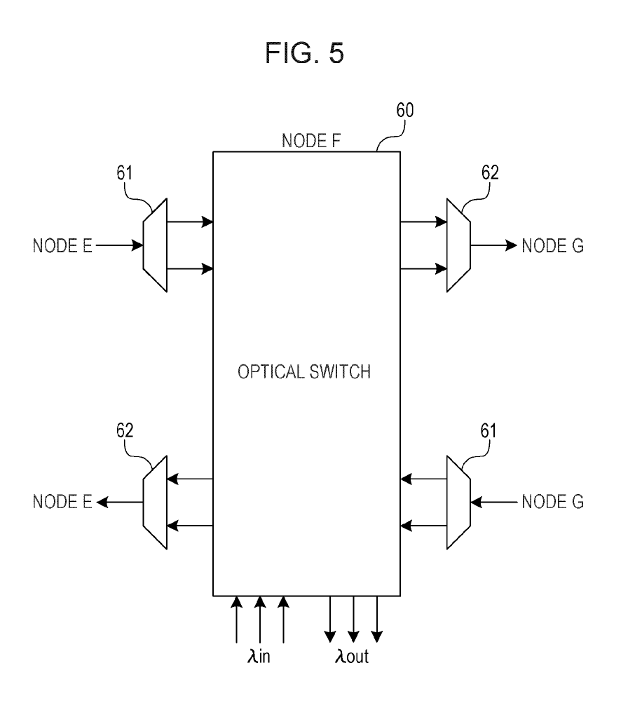

FIG. 5 is a diagram illustrating an example of the wavelength division multiplexing transmission equipment at the local nodes B, C, E to H, and J. Although FIG. 5 illustrates the configuration of the wavelength division multiplexing transmission equipment at the local node F, the configurations of the wavelength division multiplexing transmission equipment at the other local nodes B, C, E, G, H, and J are also substantially the same.

The wavelength division multiplexing transmission equipment has two multiplexers 62, two demultiplexers 61, and an optical switch 60. Each demultiplexer 61 demultiplexes an input multiplexed optical signal by splitting optical signals with different wavelengths and outputs the resulting optical signals to the optical switch 60. The demultiplexers 61 are connected to the corresponding adjacent local nodes E and G through the main transmission paths 911.

The optical switch 60 switches between destinations to which optical signals are to be output. The optical switch 60 outputs multiplexed optical signals, input from the demultiplexers 61, or optical signals λin, input from an external network, to the multiplexers 62 corresponding to the pathways to which the optical signals are to be output. The optical switch 60 also outputs only optical signals λout to be branched to an external network, out of the optical signals being included in optical signals that have been split according to the wavelengths by the demultiplexers 61.

Each multiplexer 62 multiplexes optical signals with different wavelengths. Each multiplexer 62 multiplexes optical signals input from the optical switch 60 to generate a multiplexed optical signal and outputs the multiplexed optical signal. The multiplexers 62 are connected to the corresponding adjacent local nodes E and G through the main transmission paths 911.

As described above, the number of pathways at each piece of the wavelength division multiplexing transmission equipment at the general nodes A, D, and I is 4 and the number of pathways at each piece of the wavelength division multiplexing transmission equipment at the local nodes B, C, E to H, and J is 2. Thus, the total number of multiplexers 72a and 72b and demultiplexers 71a and 71b in each piece of the wavelength division multiplexing transmission equipment at the general nodes A, D, and I is 8, and the total number of multiplexers 62 and demultiplexers 61 in the wavelength division multiplexing transmission equipment at the local nodes B, C, E to H, and J is 4.

Hence, the general nodes A, D, and I have a larger number of optical components than the local nodes B, C, E to H, and J, and thus involve a higher equipment cost than that of the local nodes B, C, E to H, and J. However, in the network illustrated in FIG. 3, since the general nodes A, D, and I are particular nodes, not all of the nodes, the equipment cost is reduced compared with the network in FIG. 2 in which all of the nodes are general nodes. For example, in order to design the network illustrated in FIG. 3, a network design apparatus according to the embodiment performs communication-route design and wavelength assignment for each requested communication channel.

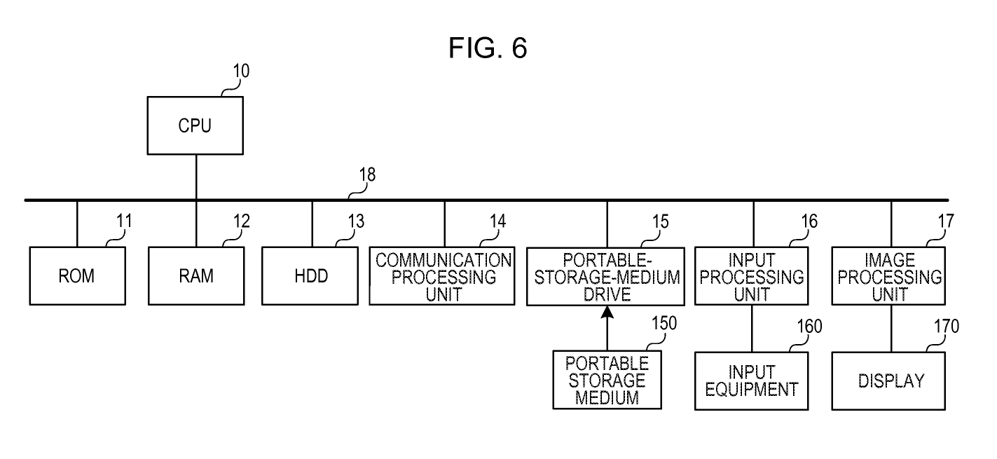

FIG. 6 is a diagram illustrating an example of a configuration of a network design apparatus, according to an embodiment. The network design apparatus is, for example, a computer apparatus such as a server. The network design apparatus includes a CPU 10, a read only memory (ROM) 11, a random access memory (RAM) 12, an HDD 13, a communication processing unit 14, a portable-storage-medium drive 15, an input processing unit 16, and an image processing unit 17.

The CPU 10 is a computational processor and performs network design processing in accordance with a network design program. The CPU 10 is communicably coupled to the aforementioned elements 11 to 17 through a bus 18. The network design apparatus 1 is not limited to an apparatus that operates on software. The CPU 10 may also be replaced with other hardware, such as an integrated circuit for a specific application.

The RAM 12 is used as a working memory for the CPU 10. The ROM 11 and the HDD 13 are used to store therein, for example, the network design program, which causes the CPU 10 to operate. The communication processing unit 14 is, for example, a network card and communicates with external apparatuses and equipment through a network, such as a local area network (LAN).

The portable-storage-medium drive 15 is equipment that writes information to and reads information from a portable storage medium 150. Examples of the portable storage medium 150 include a Universal Serial Bus (USB) memory, a recordable compact disc (CD-R), and a memory card. The network design program may also be stored in/on the portable storage medium 150.

The network design apparatus further includes input equipment 160 for performing an operation for inputting information and a display 170 for displaying images. The input equipment 160 is, for example, a keyboard, a mouse, and so on. Information input using the input equipment 160 is output to the CPU 10 via the input processing unit 16. The display 170 is, for example, a liquid-crystal display that displays images. Image data from the CPU 10 is output and displayed on the display 170 via the image processing unit 17. The input equipment 160 and the display 170 may also be replaced with equipment, such as a touch panel having those functions.

The CPU 10 executes programs stored in the ROM 11, the HDD 13, or the like or programs read from the portable storage medium 150 by the portable-storage-medium drive 15. The programs include not only an operating system (OS) but also the aforementioned network design program. The programs may also include a program downloaded via the communication processing unit 14.

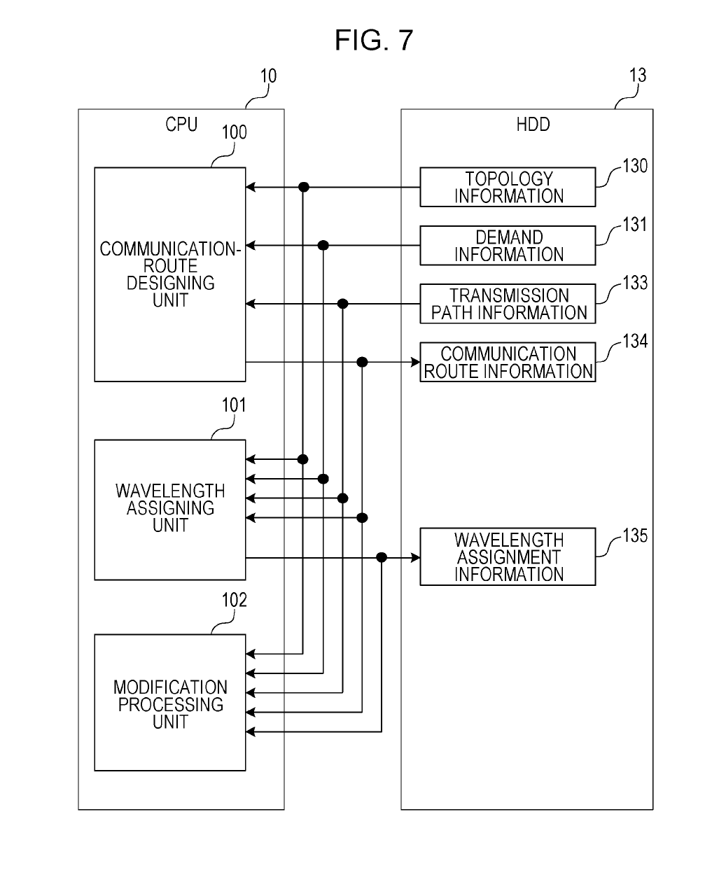

Upon executing the network design program, the CPU 10 realizes multiple functions. FIG. 7 is a diagram illustrating an example of the functions of the CPU 10 and information stored in the HDD 13, according to an embodiment.

The CPU 10 includes a communication-route designing unit 100, a wavelength assigning unit 101, and a modification processing unit 102. The HDD 13 also stores therein topology information 130, demand information 131, transmission path information 133, communication route information 134, and wavelength assignment information 135 in connection with the communication-route designing unit 100, the wavelength assigning unit 101, and the modification processing unit 102. The storage of the information 130 to 135 is not limited to the HDD 13 and may also be the ROM 11 or the portable storage medium 150.

The topology information 130, the demand information 131, and the transmission path information 133 are design information indicating conditions for designing the network. For example, the topology information 130, the demand information 131, and the transmission path information 133 may be input via the input equipment 160 by an operator or may also be downloaded from a network via the communication processing unit 14.

The topology information 130 indicates a topology of a network (see FIG. 3) to be designed, that is, the relationship of connections of the nodes A to J through links. The topology information 130 is composed, for example, by associating identifiers of a pair of nodes connected through each link in the network with an identifier of the link.

The demand information 131 indicates the contents of requests for communication channels to be established in the network. The demand information 131 includes, for example, information identifying a pair of nodes serving as termination points (a start point and an end point) of each communication channel, and the number of wavelengths used for each of the communication channels. Each pair of nodes that serve as the termination points of a communication channel is a combination of a node to which an optical signal λin is inserted and a node at which an optical signal λout is branched.

The transmission path information 133 indicates the configuration of transmission paths that provide connections between the nodes A to J in the network. The transmission path information 133 is composed by associating the number of optical fibers with a pair of nodes that serve as termination points with respect to each of the main transmission paths 911 that provide connections between all (three or more) the nodes A to J and each of the sub transmission paths 910 that provide connections between the general nodes A, D, and I.

The communication-route designing unit 100 reads the topology information 130, the demand information 131, and the transmission path information 133 and selects the sub transmission paths 910 with higher priority than the main transmission paths 911 to thereby design a communication route for each requested communication channel. Design processing of communication routes will be described below.

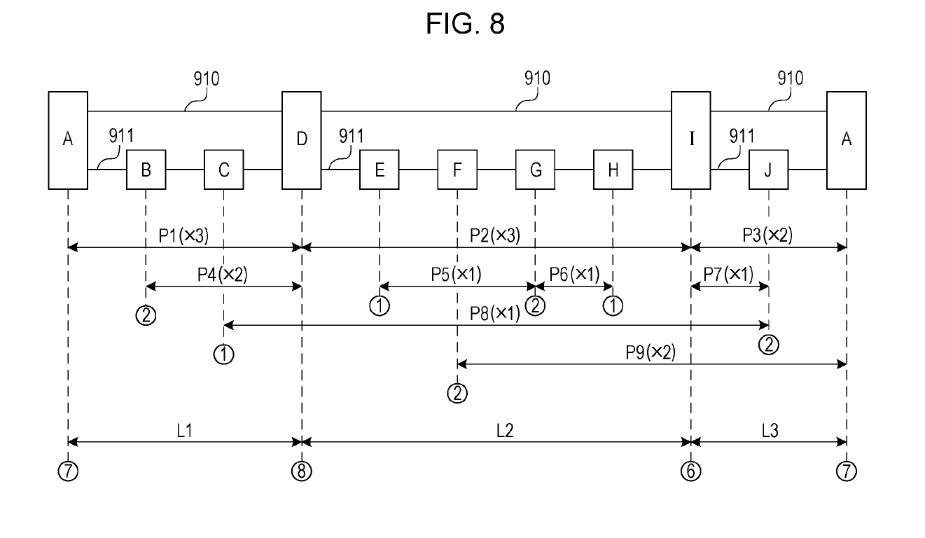

FIG. 8 is a diagram illustrating an example of the contents of the demand information 131. FIG. 8 illustrates a linearly expanded form of the network illustrated in FIG. 3. In this example, the upper limit of the number of wavelengths assignable to each transmission path is assumed to be 4.

A communication channel P1 is requested between the nodes A and D, and the number of wavelengths is 3 (see “×3” in the parentheses, which notation also applies to the following). A communication channel P2 is requested between the nodes D and I, and the number of wavelengths is 3. A communication channel P3 is requested between the nodes I and A, and the number of wavelengths is 2. A communication channel P4 is requested between the nodes B and D, and the number of wavelengths is 2. A communication channel P5 is requested between the nodes E and G, and the number of wavelengths is 1.

A communication channel P6 is requested between the nodes G and H, and the number of wavelengths is 1. A communication channel P7 is requested between the nodes I and J, and the number of wavelengths is 1. A communication channel P8 is requested between the nodes C and J, and the number of wavelengths is 1. A communication channel P9 is requested between the nodes F and A, and the number of wavelengths is 2.

In FIG. 8, each numeral indicated in a circle represents the total number of optical signals λin and λout inserted into or branched at a corresponding one of the nodes A to J. For example, in the case of the node A, since three optical signals of the communication channel P1, two optical signals of the communication channel P3, and two optical signals of the communication channel P9 are inserted or branched, the total number of optical signals λin and λout is 7. Also, in the case of the node G, since an optical signal of the communication channel P5 and an optical signal of the communication channel P6 are inserted or branched, the total number of optical signals λin and λout is 2.

In this example, the nodes A, D, and I at which the total number of optical signals λin and λout is 5 or more are referred to as general nodes, and the nodes B, C, E to H, and J at which the total number of optical signals λin and λout is 4 or less are referred to as local nodes. Thus, by determining the general nodes and the local nodes depending on the total number of optical signals λin and λout in accordance with the demand information 131, the communication-route designing unit 100 may efficiently design communication routes for the communication channels P1 to P9.

That is, since each general node is connected to both of the main transmission paths 911 and the sub transmission paths 910, the number of candidates of routes of the optical signals λin and λout is larger than that of the local node. This makes it possible to flexibly provide a communication route. When the largest number of wavelengths of optical signals transmitted to the main transmission path 911 and the sub transmission path 910 is assumed to be 4, the total number of optical signals λin and λout at each of the general nodes A, D, and I exceeds 4. Thus, the optical signals λin and λout are separately transmitted to the main transmission path 911 and the sub transmission path 910.

The communication-route designing unit 100 divides the communication channels P1 to P9 indicated by the demand information 131 into two groups, depending upon whether or not the sub transmission paths 910 are usable. More specifically, the communication-route designing unit 100 determines whether or not any of links L1 to L3 that provide connections between the general nodes exist in each of the sections of the communication channels P1 to P9, and divides the communication channels P1 to P9 into two groups in accordance with the result of the determination. The link L1 is a link between the general nodes A and D, the link L2 is a link between the general nodes D and I, and the link L3 is a link between the general nodes A and I.

In this example, the link L1 exists in the section of the communication channel P1 (between the nodes A and D), the link L2 exists in the sections of the communication channel P2 (between the nodes D and I) and the communication channel P8 (between the nodes C and J), and the link L3 exists in the sections of the communication channel P3 (between the nodes A and I) and the communication channel P9 (between the nodes A and F). Thus, the communication channels P1 to P3, P8, and P9 belong to the group that is allowed to use the sub transmission paths 910, and the other communication channels P4 to P7 belong to the group that is not allowed to use the sub transmission paths 910.

With respect to the group that is allowed to use the sub transmission paths 910, the communication-route designing unit 100 designs communication routes including the sub transmission paths 910. For example, the communication-route designing unit 100 selects a combination of the sub transmission path 910 between the general nodes D and I, the main transmission path 911 between the local nodes C and D, and the main transmission path 911 between the local nodes I and J as a communication route for the communication channel P8.

With respect to the group that is not allowed to use the sub transmission paths 910, the communication-route designing unit 100 designs a communication route including only the main transmission path(s) 911. For example, the communication-route designing unit 100 selects a combination of the main transmission path 911 between the local nodes E and F and the main transmission path 911 between the local nodes F and G as a communication route for the communication channel P5.

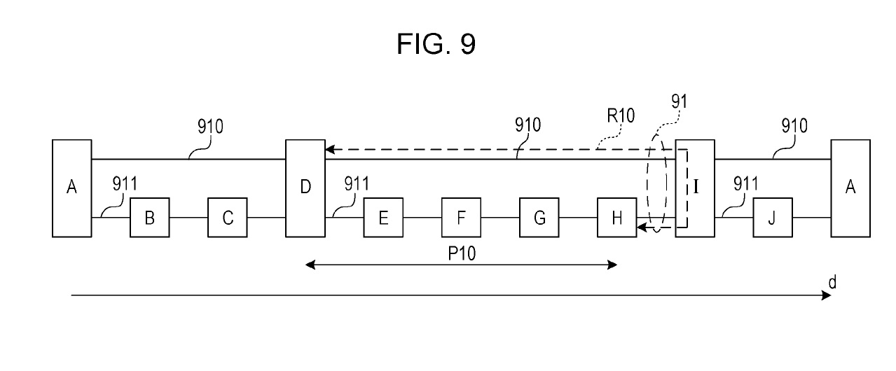

The communication-route designing unit 100 does not design a communication route through which an optical signal is turned back at a general node to an input-source node, as described above with reference to FIG. 2, in order to avoid occurrence of multiple failures. FIG. 9 is a diagram illustrating an example of a turn-back route in a network.

For example, it is assumed that a communication channel P10 is requested between the general node D and the local node H. In this case, the communication-route designing unit 100 is not allowed to select, as a communication route R10 for the communication channel P10, a combination of the sub transmission path 910 between the general nodes D and I and the main transmission path 911 between the general node I and the local node H. If the communication route R10 is permitted, multiple failures due to a break of the optical fiber cable 91 may occur between the general nodes D and I, since the optical fibers of the main transmission paths 911 and the optical fiber of the sub transmission path 910 are accommodated in the same optical fiber cable 91.

In order to avoid design of a communication route through which an optical signal is turned back toward an input-source node, optical cross-connect equipment for transmitting wavelength-multiplexed optical signals may also be used as the wavelength division multiplexing transmission equipment (see FIG. 4) provided at the general nodes A, D, and I. In this case, since the optical switches 70 regulate the pathways to which the optical signals are output, the wavelength-multiplexed optical signals are transmitted in only one direction d in the ring of the network to prohibit a turn-back communication route. A system that is different from the optical cross-connect equipment may also be used to transmit the wavelength-multiplexed optical signals in only one direction d in the ring of the network.

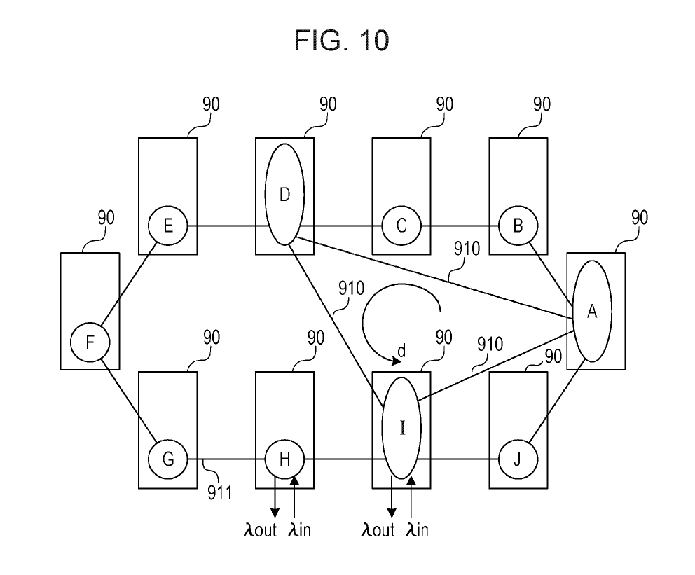

However, such a turn-back communication route may be permitted, unless the optical fibers of the main transmission path 911 and the optical fibers of the sub transmission path 910 are accommodated in the same optical fiber cable 91. FIG. 10 is a diagram illustrating another example of a network in which transmission paths between particular nodes are made redundant.

The network in this example is logically the same as the example network illustrated in FIG. 3. However, a turn-back communication route is permitted, since main transmission paths 911 and sub transmission paths 910 are installed independently from each other. Needless to say, the direction in which multiplexed optical signals are transmitted may also be limited in a certain direction d in the ring of the network in this example by using the above-described system to prohibit a turn-back communication route. Although an example in which a turn-back communication route is not permitted is described below for convenience of description, the network in this example is not excluded from a design target.

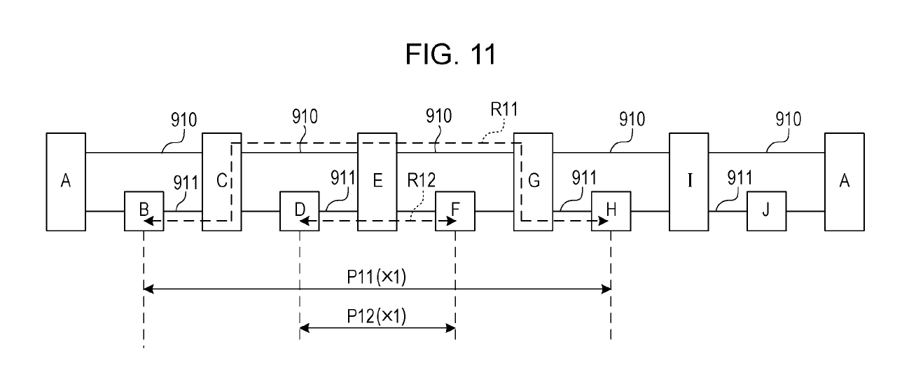

Next, details of design of communication routes will be described in conjunction with another example of the network. FIG. 11 is a diagram illustrating an example of design of communication routes in a network, according to an embodiment.

In the network in this example, general nodes A, C, E, G, and I are connected to each other through sub transmission paths 910 and are connected to local nodes B, D, F, H, and J through main transmission paths 911. The local nodes B, D, F, H, and J are connected to the general nodes A, C, E, G, and I through the main transmission paths 911. In the network in this example, a communication channel P11 is requested between the local nodes B and H, and a communication channel P12 is requested between the local nodes D and F. The number of wavelengths of each of the communication channels P11 and P12 is 1 (see “×1”).

Since a link that provides connection between the general nodes C and G exists in the section of the communication channel P11, the communication channel P11 belongs to the group that is allowed to use the sub transmission paths 910. Thus, the communication-route designing unit 100 generates following routes (1) to (3) as candidates of a communication route for the communication channel P11.

Route (1): a combination of the main transmission path 911 between the local nodes B and C, the sub transmission path 910 between the general nodes C and E, the sub transmission path 910 between the general nodes E and G, and the main transmission path 911 between the local nodes G and H.

Route (2): a combination of the main transmission path 911 between the local nodes B and C, the main transmission path 911 between the local nodes C and D, the main transmission path 911 between the local nodes D and E, the sub transmission path 910 between the general nodes E and G, and the main transmission path 911 between the local nodes G and H.

Route (3): a combination of the main transmission path 911 between the local nodes B and C, the sub transmission path 910 between the general nodes C and E, the main transmission path 911 between the local nodes E and F, the main transmission path 911 between the local nodes F and G, and the main transmission path 911 between the local nodes G and H.

Of routes (1) to (3), the communication-route designing unit 100 selects, as a communication route R11 for the communication channel P11, route (1) in which the number of sub transmission paths 910 is the largest. That is, since the number of sub transmission paths 910 in route (1) is 2 and the number of sub transmission paths 910 in each of routes (2) and (3) is 1, route (1) is selected as the communication route R11 for the communication channel P11.

On the other hand, since any link that provides connection between general nodes does not exist in the section of the communication channel P12, the communication channel P12 belongs to the group that is not allowed to use the sub transmission paths 910. Thus, the communication-route designing unit 100 selects, as a communication route for the communication channel P12, a combination of the main transmission path 911 between the local nodes D and E and the main transmission path 911 between the local nodes E and F.

As described above, the communication-route designing unit 100 uses the sub transmission path(s) 910 as much as possible, to design a communication route. That is, the communication-route designing unit 100 selects the sub transmission paths 910 with higher priority than the main transmission paths 911 to design a communication route for each requested communication channel. This is because the main transmission paths 911 have a higher degree of freedom of inserting and branching optical signals, since they are connected to all of the nodes A to J, whereas the sub transmission paths 910 have a lower degree of freedom of inserting and branching optical signals, since they are connected to only the particular nodes (general nodes).

According to such a scheme for selecting communication routes, the communication channel P11 belonging to the group that is allowed to use the sub transmission paths 910 and the communication channel P12 belonging to the group that is not allowed to use the sub transmission paths 910 are configured so that the transmission paths in the communication route R11 for the communication channel P11 and the transmission paths in the communication route R12 for the communication channel P12 are different from each other. This makes it possible to assign the same wavelength to the communication channels P11 and P12, thus making it possible to save wavelength resources.

Referring back to FIG. 7, the communication-route designing unit 100 generates, as a design result, communication route information 134 indicating a communication route for each of the requested communication channels and writes the communication route information 134 to the HDD 13. The communication route information 134 includes, for example, a combination of the identifiers each selected from at least one of the main transmission path(s) 911 and the sub transmission path(s) 910, in association with each communication channel.

The wavelength assigning unit 101 reads the topology information 130, the demand information 131, the transmission path information 133, and the communication route information 134 and assigns, for each communication channel, wavelengths included in a wavelength-multiplexed optical signal. The wavelength assigning unit 101 generates, as a result of the assignment, wavelength assignment information 135 indicating one or more wavelengths assigned to each of the requested communication channels, and writes the wavelength assignment information 135 to the HDD 13.

When the number of wavelengths assigned to communication channels that go through the sub transmission path 910 between the general nodes is larger than the number of wavelengths assigned to communication channels that go through the main transmission paths 911 between the general nodes, the modification processing unit 102 modifies the communication routes and the assignment of wavelengths. The communication routes and the assignment of wavelengths are modified so that one of the two communication channels to which the same wavelength is assigned is routed from the sub transmission path 910 to the main transmission path 911 via any of the general nodes and the other communication channel is routed from the main transmission path 911 to the sub transmission path 910 via any of the general nodes.

Since the communication-route designing unit 100 selects the sub transmission paths 910 with higher priority than the main transmission paths 911, as described above, there is a possibility that the number of wavelengths in the sub transmission path 910 becomes larger than the number of wavelengths in the main transmission path 911 between the general nodes. In this case, when the number of wavelengths in the sub transmission path 910 exceeds an upper-limit number of wavelengths that are assignable, a network is not configurable.

Thus, the modification processing unit 102 modifies the communication routes designed by the communication-route designing unit 100 and the wavelengths assigned by the wavelength assigning unit 101 so that the number of wavelengths in the main transmission path 911 and the number of wavelengths in the sub transmission path 910 are balanced. The modification processing unit 102 reflects the modified communication routes in the communication route information 134 and reflects the modified wavelengths in the wavelength assignment information 135. The communication-route and wavelength modifications will be described below in conjunction with a specific example.

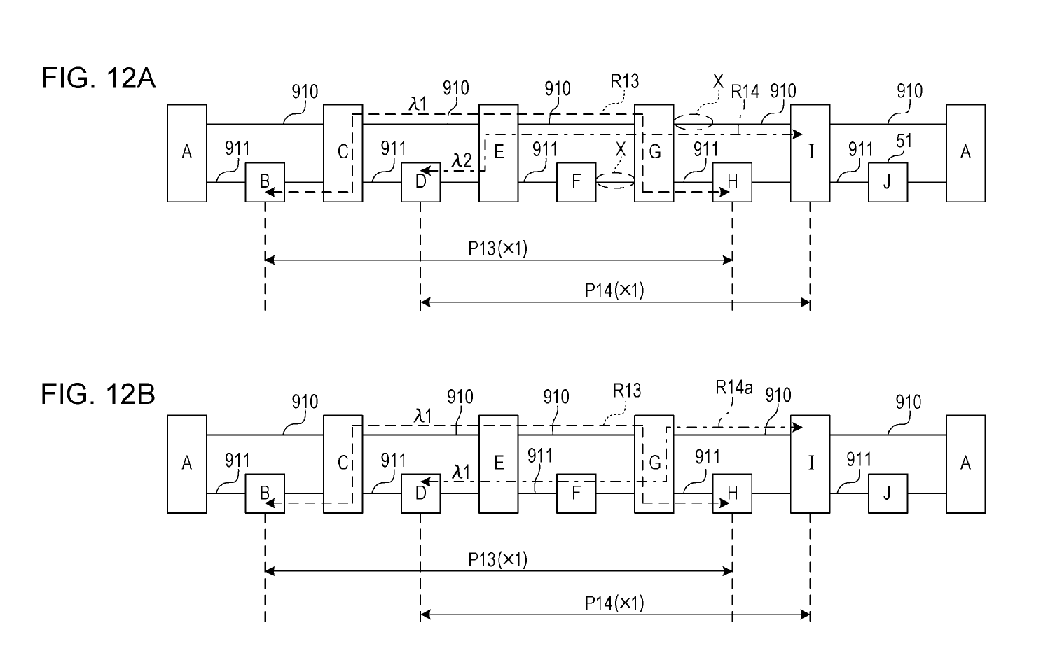

FIGS. 12A and 12B are diagrams illustrating an example of communication routes in a network before and after the modification, according to an embodiment. FIG. 12A illustrates communication routes before the modification, and FIG. 12B illustrates communication routes after the modification. The topology of the network is the same as that of the network illustrated in FIG. 11.

In the network in this example, a communication channel P13 is requested between the nodes B and H, and a communication channel P14 is requested between the nodes D and I. Since a link that provides connection between general nodes exists in the sections of each of the communication channels P13 and P14, the communication channels P13 and P14 belong to the group that is allowed to use the sub transmission paths 910. The number of wavelengths of each of the communication channels P13 and P14 is 1 (see “×1”).

As described above, the communication-route designing unit 100 selects the sub transmission paths 910 with higher priority to design a communication route. Thus, before the modification, the communication-route designing unit 100 selects, as a communication route R13 for the communication channel P13, a combination of the main transmission path 911 between the nodes B and C, the sub transmission path 910 between the nodes C and E, the sub transmission path 910 between the nodes E and G, and the main transmission path 911 between the nodes G and H. The communication-route designing unit 100 also selects, as a communication route R14 for the communication channel P14, a combination of the main transmission path 911 between the nodes D and E, the sub transmission path 910 between the nodes E and G, and the sub transmission path 910 between the nodes G and I.

Consequently, the communication route R13 for the communication channel P13 uses the same sub transmission path 910 between the nodes E and G as that in the communication route R14 for the communication channel P14. Thus, the wavelength assigning unit 101 assigns different wavelengths λ1 and λ2 to the communication channels P13 and P14. As a result, between the nodes E and G, the number of wavelengths (“2” (λ1 and λ2) in this example) assigned to the communication channels P13 and P14 that go through the sub transmission path 910 becomes larger than the number of wavelengths (“0” in this example) assigned to a communication channel that goes through the main transmission path 911.

If the upper-limit number of wavelengths in each of the main transmission path 911 and the sub transmission path 910 is assumed to be 1, the network is not configurable, since the wavelengths are not sufficient. Accordingly, by utilizing the state in which the main transmission path 911 and the sub transmission path 910 connected to the node G have an available path X for a communication route for the wavelength λ1, the modification processing unit 102 modifies the communication routes R13 and R14 so that the same wavelength is assigned to the communication channels P13 and P14. The reason why there is the available path X for a communication route for the wavelength λ1 is that design of a turn-back communication route is prohibited, as described above with reference to FIG. 9.

The modification processing unit 102 checks whether or not it is possible to modify the communication routes R13 and R14 at the general nodes E or G positioned at the opposite ends of a section of the sub transmission path 910 through which both the communication routes R13 and R14 pass so that two communication routes having the same wavelength pass through the main transmission path 911 and the sub transmission path 910, respectively. That is, the modification processing unit 102 determines whether or not it is possible to modify the communication routes R13 and R14 so that one of the communication channels P13 and P14 having the same wavelength is routed from the sub transmission path 910 to the main transmission path 911 via the general node E or G and the other one of the communication channel P13 and P14 is routed from the main transmission path 911 to the sub transmission path 910 via the general node E or G.

Although the route modification may be performed at any of the general nodes E and G, FIG. 12B illustrates a case of the general node G. The modification processing unit 102 modifies the communication route R14 for the communication channel P14 so that it passes through the main transmission path 911 between the nodes E and F and the main transmission path 911 between the nodes F and G. As a result, a communication route R14a after the modification is a combination of the main transmission path 911 between the nodes D and E, the main transmission path 911 between the nodes E and F, the main transmission path 911 between the nodes F and G, and the sub transmission path 910 between the nodes G and I.

Since the communication route R14a after the modification does not include the same transmission path 910 or 911 as that in the communication route R13 for the communication channel P13, the modification processing unit 102 changes the wavelength of the communication channel P14 from λ2 to λ1, which is the same as that of the communication channel P13. As a result, one of the two communication channels P13 and P14 to which the same wavelength λ1 is assigned is routed from the sub transmission path 910 to the main transmission path 911 via the general node G, and the other one of the two communication channels P13 and P14 is routed from the main transmission path 911 to the sub transmission path 910 via the general node G. That is, the two communication routes P13 and P14 having the same wavelength λ1 are modified at the general node G so as to interchange the main transmission path 911 and the sub transmission path 910. In this example, although a case in which the modification processing unit 102 performs wavelength modification so that both of the wavelengths of the two communication channels P13 and P14 become λ1 has been described, the wavelength modification may also be made so that both of the wavelengths become λ2.

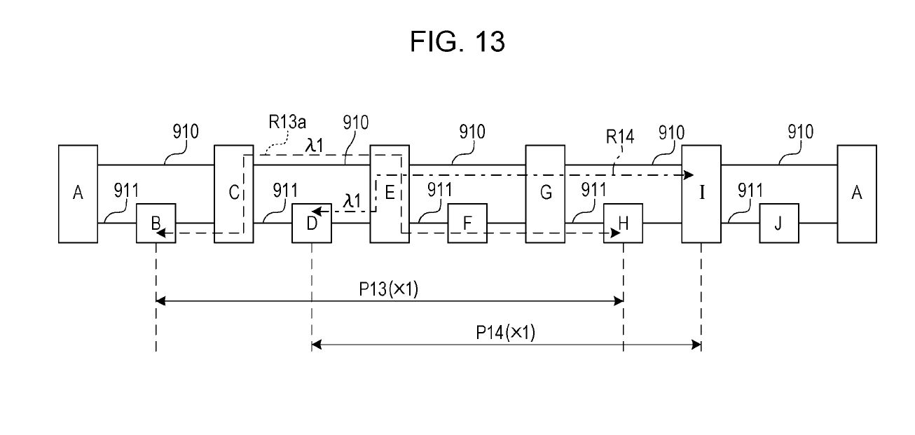

In this example, although the modification processing unit 102 performs route modification at the general node G so that the communication channels P13 and P14 having the same wavelength λ1 interchange the main transmission path 911 and the sub transmission path 910, the modification processing unit 102 may also perform the route modification at the general node E in the same manner. FIG. 13 is a diagram illustrating an example of communication routes in a network after the modification, according to an embodiment.

The modification processing unit 102 modifies the communication route R13 for the communication channel P13 so that it passes through the main transmission path 911 between the nodes E and F and the main transmission path 911 between the nodes F and G. Thus, a communication route R13a after the modification is a combination of the main transmission path 911 between the nodes B and C, the sub transmission path 910 between the nodes C and E, the main transmission path 911 between the nodes E and F, the main transmission path 911 between the nodes F and G, and the main transmission path 911 between the nodes G and H.

Since the communication route R13a after the modification does not include the same transmission path 910 or 911 as that in the communication route R14 for the communication channel P14, the modification processing unit 102 changes the wavelength of the communication channel P14 from λ2 to λ1, which is the same as that of the communication channel P13. As a result, one of the two communication channels P13 and P14 to which the same wavelength λ1 is assigned is routed from the sub transmission path 910 to the main transmission path 911 via the general node E, and the other one of the communication channel P13 and P14 is routed from the main transmission path 911 to the sub transmission path 910 via the general node E. That is, the two communication channels P13 and P14 having the same wavelength λ1 are modified at the general node E so as to interchange the main transmission path 911 and the sub transmission path 910. In this example, although a case in which the modification processing unit 102 performs wavelength modification so that both of the wavelengths of the two communication channels P13 and P14 become λ1 has been described, the wavelength modification may also be made so that both of the wavelengths become λ2.

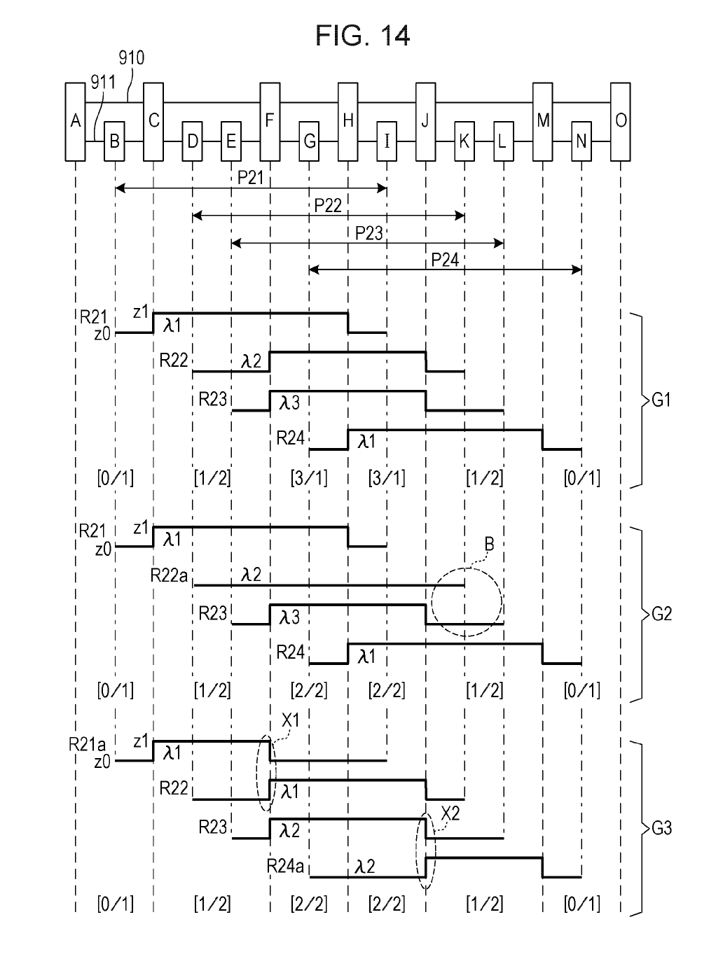

Next, the modification processing performed by the modification processing unit 102 will be further described in detail in conjunction with another specific example. FIG. 14 is a diagram illustrating an example of communication route modifications in a network, according to an embodiment.

The network in this example has nodes A to O. The nodes A, C, F, H, J, M, and O are general nodes, and the nodes B, D, E, G, I, K, L, and N are local nodes. In the network in this example, a communication channel P21 is requested between the nodes B and I, and a communication channel P22 is requested between the nodes D and K. Also, a communication channel P23 is requested between the nodes E and L, and a communication channel P24 is requested between the nodes G and N.

In FIG. 14, character G1 indicates communication routes and assigned wavelengths before the modification. Character G2 indicates communication routes and assigned wavelengths after the modification as a comparative example, and character G3 indicates communication routes and assigned wavelengths in the embodiment.

The communication routes R21 to R24, R21a, R22a, and R24a are represented by lines that extend horizontally at vertical positions z0 and z1. The lines that extend horizontally at vertical position z1 represent the sub transmission paths 910, and the lines that extend horizontally at vertical position z0 represent the main transmission paths 911.

Two numerals indicated in brackets (see “[1/2]” and so on) indicate, between the general nodes, the number of wavelengths in the communication channel(s) that go through the sub transmission path 910 and the number of wavelengths in the communication channel(s) that go through the main transmission path 911. For example, with respect to the communication routes before the modification (see character G1) between the general nodes F and H, “[3/1]” indicates that the number of wavelengths in the communication channels P21 to P23 passing through the sub transmission path 910 is 3, and the number of wavelengths in the communication channel P24 passing through the main transmission path 911 between the general nodes F and H is 1.

First, a reference is made to the communication routes before the modification. The communication route R21 for the communication channel P21 is a combination of the main transmission path 911 between the nodes B and C, the sub transmission path 910 between the nodes C and F, the sub transmission path 910 between the nodes F and H, and the main transmission path 911 between the nodes H and I. The communication route R22 for the communication channel P22 is a combination of the main transmission path 911 between the nodes D and E, the main transmission path 911 between the nodes E and F, the sub transmission path 910 between the nodes F and H, the sub transmission path 910 between the nodes H and J, and the main transmission path 911 between the nodes J and K. The communication route R23 for the communication channel P23 is a combination of the main transmission path 911 between the nodes E and F, the sub transmission path 910 between the nodes F and H, the sub transmission path 910 between the nodes H and J, the main transmission paths 911 between the nodes J and K, and the main transmission paths 911 between the nodes K and L. The communication route R24 for the communication channel P24 is a combination of the main transmission path 911 between the nodes G and H, the sub transmission path 910 between the nodes H and J, the sub transmission path 910 between the nodes J and M, and the main transmission path 911 between the nodes M and N.

A wavelength λ1 is assigned to the communication channel P21, and a wavelength λ2 is assigned to the communication channel P22. A wavelength λ3 is assigned to the communication channel P23, and a wavelength λ1 is assigned to the communication channel P24.

Between the general nodes F and H, the number of wavelengths assigned to the communication channels P21 to P23 that pass through the sub transmission path 910 is 3, and the number of wavelengths assigned to the communication channel P24 that pass through the main transmission path 911 is 1. Between the general nodes H and J, the number of wavelengths assigned to the communication channels P22 to P24 that pass through the sub transmission path 910 is 3, and the number of wavelengths assigned to the communication channel P21 that passes through the main transmission path 911 is 1.

Thus, since the number of wavelengths assigned to the communication channels P22 to P24 that pass through the sub transmission paths 910 between the nodes F and H and between the nodes H and J is larger than the number of wavelengths assigned to the communication channel P21 that passes through the main transmission paths 911 between the nodes F and H and between the nodes H and J, the modification processing unit 102 causes the above two numbers of wavelengths to be balanced.

In the comparative example (see character G2), the communication route R22 for the communication channel P22 has been modified from the sub transmission paths 910 to the main transmission paths 911 between the general nodes F and H and between the general nodes H and J. Thus, the communication route R22a after the modification is a combination of only the main transmission paths 911 that provide connections between the nodes D and K.

As a result of such a modification to the communication route R22, the number of wavelengths in the communication channels P22 to P24 that pass through the sub transmission paths 910 between the general nodes F and H and between the general nodes H and J is 2, and the number of wavelengths in the communication channel P21 that passes through the main transmission paths 911 is 2. As a result, the numbers of wavelengths between the general nodes F and H and between the general nodes H and J become balanced.

However, since the communication route R22a after the modification uses the same main transmission path 911 as that of the communication route R23 for the communication channel P23, wavelength blocking occurs (see character B). Consequently, the communication channels P22 and P23 use the mutually different wavelengths λ2 and λ3, and the number of wavelengths in the entire network becomes 3, which is the same as the number of wavelengths before the modification.

In contrast, in the embodiment (see character G3), the communication route R21 for the communication channel P21 has been modified from the sub transmission path 910 to the main transmission paths 911 between the general nodes F and H. Also, the communication route R24 for the communication channel P24 has been modified from the sub transmission path 910 to the main transmission paths 911 between the general nodes H and J.

Thus, the communication route R21a after the modification is a combination of the main transmission path 911 between the nodes B and C, the sub transmission path 910 between the nodes C and F, the main transmission path 911 between the nodes F and G, the main transmission path 911 between the nodes G and H, and the main transmission path 911 between the nodes H and I. Also, the communication route R24a after the modification is a combination of the main transmission path 911 between the nodes G and H, the main transmission path 911 between the nodes H and I, the main transmission path 911 between the nodes I and J, the sub transmission path 910 between the nodes J and M, and the main transmission path 911 between the nodes M and N.

As a result of such modifications to the communication route R21 and R24, the number of wavelengths in the communication channels P22 and P23 that pass through the sub transmission paths 910 between the general nodes F and H and between the general nodes H and J is 2, and the number of wavelengths in the communication channels P21 and P22 that pass through the main transmission paths 911 is 2. As a result, the numbers of wavelengths between the general nodes F and H and between the general nodes H and J become balanced.

In this case, since the communication routes R21a and R22 do not use the same transmission path 910 or 911 and thus no wavelength blocking occurs, the communication channels P21 and P22 may use the same wavelength λ1. Similarly, since the communication routes R23 and R24a do not use the same transmission path 910 or 911 and thus no wavelength blocking occurs, the communication channels P23 and P24 can use the same wavelength λ2.

That is, the communication route R21 and the wavelengths are modified so that one of the communication channels P21 and P22 to which the same wavelength λ1 is assigned is routed from the sub transmission path 910 to the main transmission path 911 via the general node F and the other one of the communication channels P21 and P22 is routed from the main transmission path 911 to the sub transmission path 910 via the general node F (character X1). Also, the communication route R24 and the wavelengths are modified so that one of the communication channels P23 and P24 to which the same wavelength λ2 is assigned is routed from the sub transmission path 910 to the main transmission path 911 via the general node J and the other one of the communication channels P23 and P24 is routed from the main transmission path 911 to the sub transmission path 910 via the general node J (character X2).

According to the embodiment, as described above, it is possible not only to make the number of wavelengths balance with each other but also to reduce the number of wavelengths in the entire network from 3 to 2, unlike the comparative example.

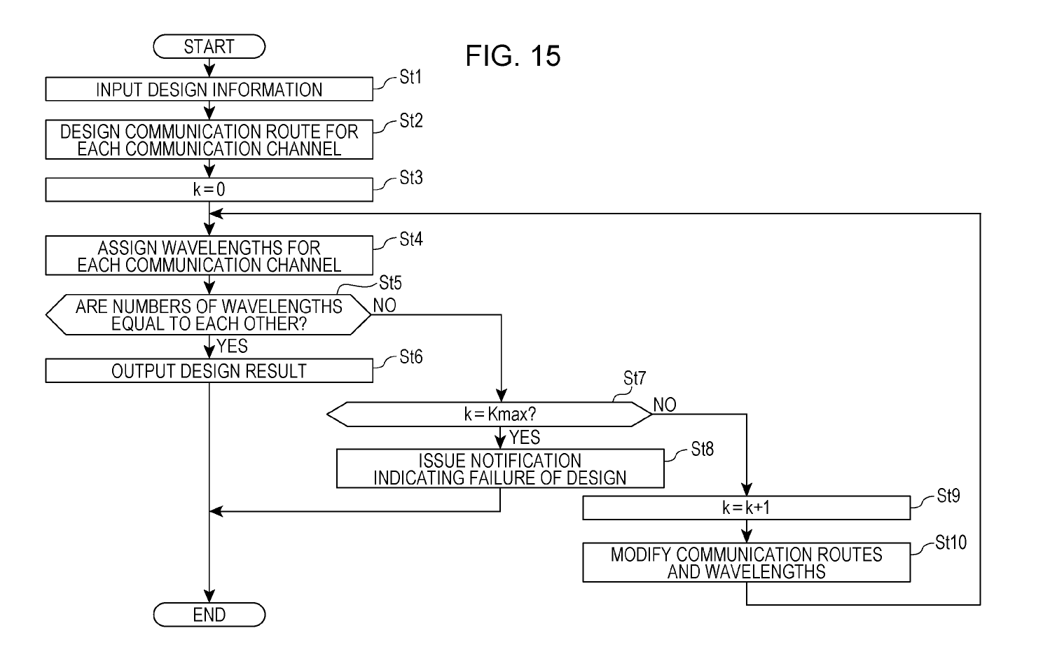

Next, a description will be given of the operation of the network design apparatus. FIG. 15 is a diagram illustrating an example of an operational flowchart for a network design method, according to an embodiment.

First, in step St1, an operator inputs design information to the network design apparatus via the input equipment 160 or the communication processing unit 14. The design information includes the topology information 130, the demand information 131, and the transmission path information 133. The design information is stored in the HDD 13.

Next, in step St2, based on the topology information 130, the demand information 131, and the transmission path information 133, the communication-route designing unit 100 designs a communication route for each of the requested communication channels. In this case, the communication-route designing unit 100 selects, with higher priority, the sub transmission paths 910 that provide connections between particular nodes (general nodes) in the network than the main transmission paths 911 that provide connections between all (three or more) nodes in the network, as described above.

For example, the communication-route designing unit 100 generates a model for a mixed integer programming problem for communication routes and obtains a solution thereof to determine the communication route. The mixed integer programming problem is an analysis method for obtaining a maximum value or a minimum value of an objective function under one or more constraints.

In step St3, the CPU 10 sets a variable k at 0. The variable k indicates the number of times the wavelength assigning unit 101 has executed wavelength assignment.

In step St4, the wavelength assigning unit 101 assigns, for each communication channel, wavelengths included in a wavelength-multiplexed optical signal in the network. In this case, for example, the wavelength assigning unit 101 generates a model for the mixed integer programming problem for wavelengths and obtains a solution to execute wavelength assignment. The constraint for the mixed integer programming problem is that, for example, the same wavelength is not assignable to communication channels that pass through the same main transmission path 911 or sub transmission path 910. In other words, the constraint is that the same wavelength is not assignable to communication channels that share at least part of the communication routes.

In step St5, the modification processing unit 102 determines whether or not the number of wavelengths assigned to the communication channel(s) that pass through the sub transmission path 910 between the general nodes and the number of wavelengths assigned to the communication channel(s) that pass through the main transmission paths 911 between the general nodes are balanced with each other. When the numbers of wavelengths are balanced with each other (YES in step St5), the network design apparatus outputs a design result in step St6 and then ends the processing. In this case, the design result may not only be stored in the HDD 13 as the communication route information 134 and the wavelength assignment information 135 but also be displayed on the display 170.

On the other hand, when the numbers of wavelengths are not balanced with each other (NO in step St5), the process proceeds to step St7 in which the CPU 10 determines whether or not the variable k has reached a predetermined value Kmax. When the variable k has reached the predetermined value Kmax (YES in step St7), the network design apparatus issues a notification indicating that the design has failed in step St8 and ends the processing. The failure notification is, for example, displayed on the display 170. Since the number of times the wavelength assigning unit 101 executes the wavelength assignment is limited to the predetermined value Kmax, as described above, the network design apparatus is prohibited from permanently repeating design of a network to which wavelengths are not assignable.

When the variable k is smaller than the predetermined value Kmax (NO in step St7), the CPU 10 adds “1” to the variable k in step St9. Next, in step St10, the modification processing unit 102 modifies the communication routes designed by the communication-route designing unit 100 and the wavelengths assigned by the wavelength assigning unit 101. The communication-route and wavelength modifications are performed so that one of the two communication channels to which the same wavelength is assigned is routed from the sub transmission path 910 to the main transmission path 911 and the other one of the two communication channels is routed from the main transmission path 911 to the sub transmission path 910.

In order to reflect information of the modified communication routes and wavelengths, the modification processing unit 102 updates the communication route information 134 and the wavelength assignment information 135. In step St4, the wavelength assigning unit 101 executes the wavelength assignment again, based on the updated the communication route information 134 and wavelength assignment information 135. Thereafter, the process in step St5 and the subsequent processes are repeated. The network design is performed in the manner described above.

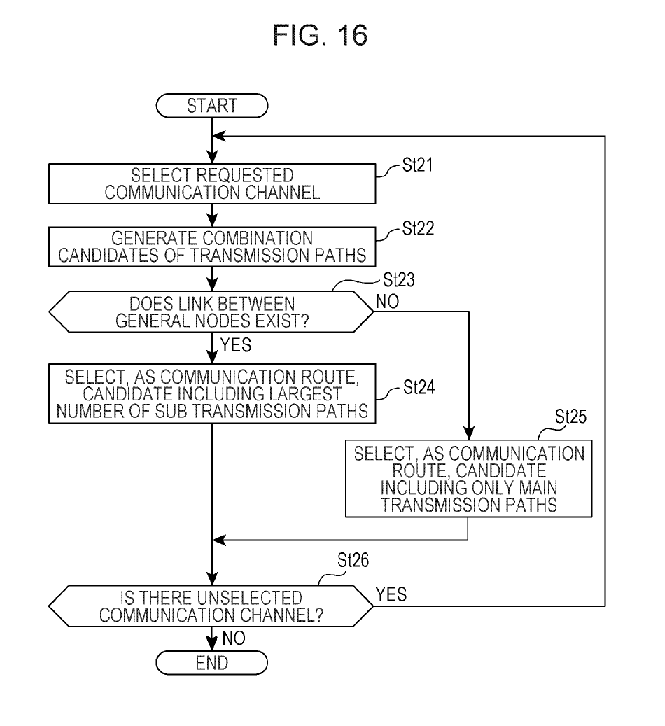

Next, a description will be given of the communication-route design processing (step St2 in FIG. 15). FIG. 16 is a diagram illustrating an example of an operational flowchart for communication-route design processing, according to an embodiment.

First, in step St21, the communication-route designing unit 100 reads the demand information 131 from the HDD 13 and selects a requested communication channel. Next, in step St22, the communication-route designing unit 100 reads the topology information 130 and the transmission path information 133 from the HDD 13, and generates communication-route candidates by selecting combination candidates of the transmission paths 910 and 911 for each section (a pair of nodes) of the communication channel, as described above with reference to FIG. 11.

Next, in step St23, based on the topology information 130, the communication-route designing unit 100 determines whether or not a link between general nodes exists in the section of the selected communication channel. When a link between general nodes exists (YES in step St23), the communication-route designing unit 100 classifies the selected communication channel into the group that is allowed to use the sub transmission paths 910. In step St24, the communication-route designing unit 100 selects, as a communication route, a communication-route candidate including the largest number of the sub transmission paths 910 among the generated communication-route candidates. In the case of the example illustrated in FIG. 11, the communication-route designing unit 100 selects candidate route (1) among candidate routes (1) to (3).

On the other hand, when a link between general nodes does not exist (NO in step St23), the communication-route designing unit 100 classifies the selected communication channel into the group that is not allowed to use the sub transmission paths 910. In step St25, the communication-route designing unit 100 selects, as a communication route, a candidate including only the main transmission paths 911.

Next, in step St26, based on the demand information 131, the communication-route designing unit 100 determines whether or not there is an unselected communication channel. When there is an unselected communication channel (YES in step St26), the communication-route designing unit 100 selects the unselected communication channel in step St21 and executes the process in step St22 again. When there is no unselected communication channel left (NO in step St26), the communication-route designing unit 100 ends the processing. The communication-route design processing is executed in the manner described above.

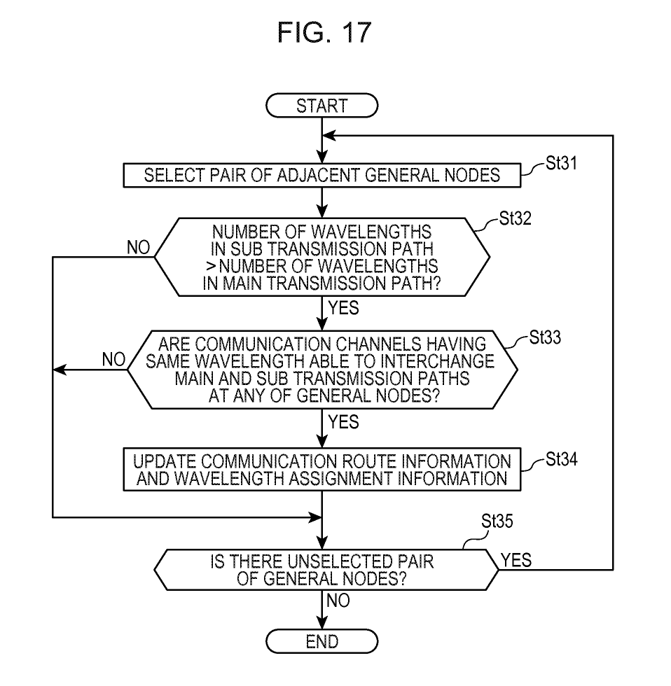

Next, a description will be given of the communication-route and wavelength modification processing (step St10 in FIG. 15). FIG. 17 is a diagram illustrating an example of an operational flowchart for communication-route and wavelength modification processing, according to an embodiment.

First, in step St31, based on the topology information 130, the modification processing unit 102 selects a pair of adjacent general nodes. In the case of the example illustrated in FIG. 12A, the modification processing unit 102 selects one of a pair of the nodes A and C, a pair of the nodes C and E, a pair of the nodes E and G, a pair of the nodes G and I, and a pair of the nodes I and A.

In step St32, the modification processing unit 102 determines whether or not the number of wavelengths assigned to the communication channel(s) that pass through the sub transmission path(s) 910 between the selected general nodes is larger than the number of wavelengths assigned to the communication channel(s) that pass through the main transmission path(s) 911 between the selected general nodes. When the number of wavelengths in the sub transmission path 910 is larger than the number of wavelengths in the main transmission path(s) 911 (YES in step St32), the process proceeds to step St33 in which the modification processing unit 102 determines whether or not the main transmission path 911 and the sub transmission path 910 of the communication channels having the same wavelength are interchangeable at any of the general nodes.

That is, the modification processing unit 102 determines whether or not the communication routes and the wavelengths are able to be modified so that one of the two communication channels to which the same wavelength is assigned is routed from the sub transmission path 910 to the main transmission path 911 via any of the general nodes and the other one of the two communication channels is routed from the main transmission path 911 to the sub transmission path 910 via any of the general nodes. In the case of the example illustrated in FIG. 12A, the modification processing unit 102 makes the determination with respect to any of the general nodes E and G.

When the interchange of the main transmission path 911 and the sub transmission path 910 is possible (YES in step St33), the process proceeds to step St34 in which the modification processing unit 102 updates the communication route information 134 and the wavelength assignment information 135. When the interchange of the main transmission path 911 and the sub transmission path 910 is not possible (NO in step St33) or when the number of wavelengths in the sub transmission path 910 is smaller than or equal to the number of wavelengths in the main transmission path(s) 911 (NO in step St32), the modification processing unit 102 does not perform the above-described update.

In step St35, based on the topology information 130, the modification processing unit 102 determines whether or not there is an unselected pair of general nodes. When there is an unselected pair of general nodes (YES in step St35), the modification processing unit 102 selects the unselected pair of general nodes in step St31 and then executes the process in step St32 again. When an unselected pair of general nodes does not exist (NO in step St35), the modification processing unit 102 ends the processing. The communication-route and wavelength modification processing is executed in the manner described above.

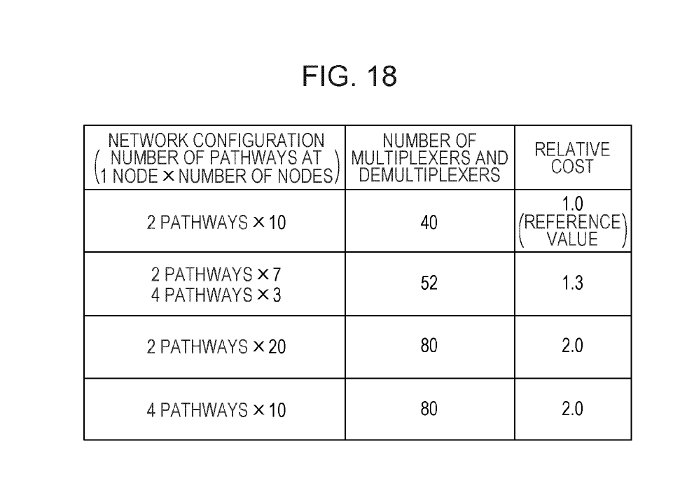

Next, a description will be given of the cost of nodes in a network to be designed. FIG. 18 is a diagram illustrating an example of costs for respective network configurations, according to an embodiment.

The costs illustrated in FIG. 18 are calculated based on the total number of demultiplexers 71a, 71b, and 61 and multiplexers 72a, 72b, and 62 (“the total number of multiplexers and demultiplexers”) illustrated in FIGS. 4 and 5. The wavelength division multiplexing transmission equipment (a ROADM or the like) installed at each node has optical amplifiers for the respective pathways in order to compensate for loss of optical power of multiplexed optical signals, which is caused by the demultiplexers and the multiplexers. The demultiplexers, the multiplexers, and the optical amplifiers are expensive, thus greatly affecting the equipment cost. In practice, the equipment cost also includes fixed costs that do not depend on the number of pathways, such as the cost of a power source unit.

Since the wavelength division multiplexing transmission equipment at each general node has four demultiplexers 71a and 71b and four multiplexers 72a and 72b for four pathways, as illustrated in FIG. 4, the number of multiplexers and demultiplexers is 8. On the other hand, since the wavelength division multiplexing transmission equipment at each local node has two demultiplexers 61 and two multiplexers 62 for two pathways, as illustrated in FIG. 5, the number of multiplexers and demultiplexers is 4.

Thus, in the case of a network configuration in which ten nodes (corresponding to local nodes), each having two pathways, are provided, the number of multiplexers and demultiplexers is 40. The “relative cost” in FIG. 18 indicates, when the cost of this network is assumed to be 1.0 (reference value), the costs of other network configurations. All of the network configurations are assumed to be ring networks.

In the case of a network configuration (see FIG. 3) in which seven nodes (local nodes), each having two pathways, are provided and three nodes (general nodes), each having four pathways, are provided, the number of multiplexers and demultiplexers is 52. Thus, the relative cost in this network configuration is 1.3, which is given by the ratio of the multiplexers and demultiplexers (52/40).

In the case of a network configuration (see FIG. 1) in which 20 nodes (corresponding to local nodes), each having two pathways, are provided, the number of multiplexers and demultiplexers is 80. Thus, the relative cost of this network configuration is 2.0, which is given by the ratio of the multiplexers and demultiplexers (80/40).

In the case of a network configuration (see FIG. 2) in which ten nodes (corresponding to general nodes), each having four pathways, are provided, the number of multiplexers and demultiplexers is 80. Thus, the relative cost of this network configuration is 2.0, which is given by the ratio of the multiplexers and demultiplexers (80/40).

Hence, the equipment cost is reduced by 35% when the network illustrated in FIG. 3 is used, compared with a case in which the networks illustrated in FIGS. 1 and 2 are used. Even when compared with the simple network in which ten nodes, each having two pathways, are provided, the network illustrated in FIG. 3 also makes it possible to reduce an increase in the equipment cost up to about 30(%).

As described above, the network design apparatus includes the communication-route designing unit 100, the wavelength assigning unit 101, and the modification processing unit 102. The communication-route designing unit 100 designs a communication route for each requested communication channel, by selecting, with higher priority, the sub transmission paths 910 that provide connections between particular nodes (general nodes) in the network in which a wavelength-multiplexed optical signal is transmitted, than the main transmission paths 911 that provide connections between all (three or more) nodes in the network.

The wavelength assigning unit 101 assigns, for each communication channel, wavelengths included in a wavelength-multiplexed optical signal. When the number of wavelengths assigned to the communication channel(s) that pass through the sub transmission path 910 between the particular nodes is larger than the number of wavelengths assigned to the communication channel(s) that pass through the main transmission paths 911 between the particular nodes, the modification processing unit 102 modifies the communication routes designed by the communication-route designing unit 100 and the wavelengths designed by the wavelength assigning unit 101. The communication-route and wavelength modifications are performed so that one of the two communication channels to which the same wavelength is assigned is routed from the sub transmission path to the main transmission path via any of the particular nodes and the other one of the two communication channels is routed from the main transmission path to the sub transmission path via any of the particular nodes.

According to the configuration described above, the main transmission paths 911 provide connections between three or more nodes in the network, and the sub transmission paths 910 provide connections between particular nodes (general nodes) in the network. Accordingly, the transmission paths between the particular nodes are made redundant, thus making it possible to increase the transmission capacity of the network while reducing the cost.

The communication-route designing unit 100 also selects the sub transmission paths 910 with higher priority than the main transmission paths 911 to design a communication route for each requested communication channel. Thus, as many communication routes as possible may be concentrated through the sub transmission paths 910 whose degree of freedom of inserting and branching optical signals is lower than the main transmission paths 911.

Since the wavelength assigning unit 101 assigns, for each communication channel, wavelengths included in a wavelength-multiplexed optical signal, the number of wavelengths used is determined for each of the main transmission paths 911 and the sub transmission paths 910.

When the number of wavelengths in the sub transmission path(s) 910 between particular nodes is larger than the number of wavelengths in the main transmission path 911, the modification processing unit 102 modifies the communication routes designed by the communication-route designing unit and the wavelengths assigned by the wavelength assigning unit. Accordingly, even if the number of wavelengths in the main transmission path 911 becomes larger than the number of wavelengths in the main transmission path 911 as a result of selecting the sub transmission path 910 with higher priority to design communication routes, the number of wavelengths in the sub transmission path 910 and the number of wavelengths in the sub transmission path 910 may be made balanced with each other.

In this case, since the communication-route and wavelength modifications are performed so that one of the two communication channels to which the same wavelength is assigned is routed from the sub transmission path to the main transmission path via any of the particular nodes and the other one of the two communication channels is routed from the main transmission path to the sub transmission path via any of the particular nodes, the number of wavelengths in the transmission paths 910 and 911 is reduced. Hence, the equipment cost at each node is reduced.

Accordingly, the network design apparatus according to the embodiment makes it possible to effectively design a network that allows large-capacity transmission.

Also, the network design method according to the embodiment is a method for causing a computer to execute processes (1) to (3) below.

Process (1): a communication route for each requested communication channel is designed by selecting, with higher priority, sub transmission paths 910 that provide connections between particular nodes in a network in which a wavelength-multiplexed optical signal is transmitted than main transmission paths 911 that provide connections between three or more nodes in the network.

Process (2); wavelengths included in the wavelength-multiplexed optical signal are assigned for each communication channel.

Process (3): when the number of wavelengths assigned to the communication channel that passes through the sub transmission path 910 between the particular nodes is larger than the number of wavelengths assigned to the communication channel that passes through the main transmission path 911 between the particular nodes, the communication routes designed in the process for designing the communication paths and the wavelengths assigned in the process for assigning the wavelengths are modified. The communication-route and wavelength modifications are performed so that one of the two communication channels to which the same wavelength is assigned is routed from the sub transmission path 910 to the main transmission path 911 via any of the particular nodes and the other one of the two communication channels is routed from the main transmission path 911 to the sub transmission path 910 via any of the particular nodes.

The network design method according to the embodiment offers advantages that are the same as or similar to those described above, since it is applied to a configuration that is the same as or similar to that of the above-described network design apparatus.

Also, the network design program according to the embodiment is a program for causing a computer to execute processing (1) to (3) below.

Processing (1): a communication route for each requested communication channel is designed by selecting, with higher priority, sub transmission paths 910 that provide connections between particular nodes in a network in which a wavelength-multiplexed optical signal is transmitted than main transmission paths 911 that provide connections between three or more nodes in the network.

Processing (2): wavelengths included in the wavelength-multiplexed optical signal are assigned for each communication channel.

Processing (3): when the number of wavelengths assigned to the communication channel that goes through the sub transmission path 910 between the particular nodes is larger than the number of wavelengths assigned to the communication channel that goes through the main transmission path 911 between the particular nodes, the communication routes designed in the processing for designing the communication paths and the wavelengths assigned in the processing for assigning the wavelengths are modified. The communication-route and wavelength modifications are performed so that one of the two communication channels to which the same wavelength is assigned is routed from the sub transmission path 910 to the main transmission path 911 via any of the particular nodes and the other communication channel is routed from the main transmission path 911 to the sub transmission path 910 via any of the particular nodes.

The network design program according to the embodiment offers operational effects that are the same as or similar to those described above, since it is applied to a configuration that is the same as or similar to that of the above-described network design apparatus.

Although the contents of the present disclosure have been specifically described above with reference to the preferred embodiments, it is apparent to those skilled in the art that various modification and changes are possible based on the basic technical spirit and the teaching of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A network design apparatus comprising:
a processor configured:
to design a communication route for each of requested communication channels by selecting, with higher priority, first transmission paths providing connections between particular nodes in a network in which a wavelength-multiplexed optical signal is transmitted than second transmission paths providing connections between three or more nodes in the network,
to assign, for each communication channel, a wavelength included in the wavelength-multiplexed optical signal, and
to modify, when a first number of wavelengths assigned to the communication channels passing through the first transmission paths between the particular nodes is greater than a second number of wavelengths assigned to the communication channels passing through the second transmission paths between the particular nodes, the designed communication routes and the assigned wavelengths so that one of two communication channels having a same wavelength is routed from the first transmission paths to the second transmission paths via any of the particular nodes and other one of the two communication channels is routed from the second transmission paths to the first transmission paths via any of the particular nodes; and
a memory coupled to the processor, configured to store information on the communication channels and the first and second transmission paths.

2. The network design apparatus of claim 1, wherein
the wavelength-multiplexed optical signal is transmitted in one direction.

3. The network design apparatus of claim 1, wherein
optical cross-connect equipment that transmits the wavelength-multiplexed optical signal is provided at each of the particular nodes.

4. The network design apparatus of claim 1, wherein
the first and second transmission paths that provide connections between a same pair of nodes in the network are accommodated in a same communication cable.

5. A network design method causing a computer to execute a process comprising:
designing a communication route for each of requested communication channels by selecting, with higher priority, first transmission paths providing connections between particular nodes in a network in which a wavelength-multiplexed optical signal is transmitted than second transmission paths providing connections between three or more nodes in the network;
assigning, for each communication channel, a wavelength included in the wavelength-multiplexed optical signal; and
modifying, when a first number of wavelengths assigned to the communication channels passing through the first transmission paths between the particular nodes is greater than a second number of wavelengths assigned to the communication channels passing through the second transmission paths between the particular nodes, the designed communication routes and the assigned wavelengths so that one of the two communication channels having a same wavelength is routed from the first transmission paths to the second transmission paths via any of the particular nodes and other one of the two communication channels is routed from the second transmission paths to the first transmission paths via any of the particular nodes.

6. The network design method of claim 5, wherein
the wavelength-multiplexed optical signal is transmitted in one direction.

7. The network design method of claim 5, wherein
optical cross-connect equipment that transmits the wavelength-multiplexed optical signal is provided at each of the particular nodes.

8. The network design method of claim 5, wherein
the first and second transmission paths that provide connections between a same pair of nodes in the network are accommodated in a same communication cable.

9. A non-transitory, computer-readable recording medium having stored therein a program for causing a computer to execute a process comprising:
designing a communication route for each of requested communication channels by selecting, with higher priority, first transmission paths providing connections between particular nodes in a network in which a wavelength-multiplexed optical signal is transmitted than second transmission paths providing connections between three or more nodes in the network;
assigning, for each communication channel, a wavelength included in the wavelength-multiplexed optical signal; and
modifying, when a first number of wavelengths assigned to the communication channels passing through the first transmission paths between the particular nodes is greater than a second number of wavelengths assigned to the communication channels passing through the second transmission paths between the particular nodes, the designed communication routes and the assigned wavelengths so that one of the two communication channels having a same wavelength is routed from the first transmission paths to the second transmission paths via any of the particular nodes and other one of the two communication channels is routed from the second transmission paths to the first transmission paths via any of the particular nodes.

10. The non-transitory, computer-readable recording medium of claim 9, wherein
the wavelength-multiplexed optical signal is transmitted in one direction.

11. The non-transitory, computer-readable recording medium of claim 9, wherein
optical cross-connect equipment that transmits the wavelength-multiplexed optical signal is provided at each of the particular nodes.

12. The non-transitory, computer-readable recording medium of claim 9, wherein
the first and second transmission paths that provide connections between a same pair of nodes in the network are accommodated in a same communication cable.
